(19) United States
(12) Patent Application Publication
(10) Pub. No.: US 2010/0008402 A1
(43) Pub. Date: Jan. 14, 2010

(54) TRANSMITTER AND SYNCHRONIZATION CHANNEL FORMING METHOD

(75) Inventors: Tomohiro Sugawara, Miyagi (JP); Yuta Seki, Kanagawa (JP); Hiroki Haga, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/523,976

(22) PCT Filed: Jan. 23, 2007
(86) PCT No.: PCT/JP2007/050991

§ 371 Date: Jul. 21, 2009

(51) Int. Cl. H04B 1/69

(52) U.S. Cl. 375/139; 375/E01.001

(57) ABSTRACT

Reduction in the detection accuracy of synchronization timing at the receiving end is prevented even if a GCL system changes in response to a GCL ID. A transmitter (100) has a GCL system generating section (101) for generating a GCL system signal, a scramble processing section (102) for scrambling the GCL system signal, and a sub-carrier mapping section (103) for arranging the scrambled GCL system signal in a sub-carrier in the direction of a frequency. With this, the peak width of the differential correlation value of the GCL system at the receiving end is narrowed, so that accurate synchronization timing can be detected at the receiving end.

### TECHNICAL FIELD

The present invention relates to a transmitting apparatus and a synchronization channel forming method. More particularly, the present invention relates to a technique of transmitting a synchronization channel in an OFDM signal.

### BACKGROUND ART

The standards organization 3GPP is currently studying 3GPP RAN LTE (Long Term Evolution) for the purpose of realizing an enhanced system for third-generation mobile telephones.

The LTE standardization conference is currently discussing the sequence to map to the synchronization channel (SCH) for detecting synchronization of OFDM signals, and various companies are proposing methods of mapping the GCL (Generalized Chirp-Like) sequence (see Non-Patent Documents 1 to 4). The GCL sequence sᵤ(k) is a sequence represented by the following equation.

[1]

$${s}_{u} ( k ) = exp \{ - j2 π u \frac{k ( k + 1 )}{2 {N}_{G}} \} \qquad ( Equation 1 )$$

Here, “u” is the sequence index that is used to detect cell IDs and so on (hereinafter “GCL ID”) and “N_{G}” is a prime number that is equal to or greater than the length of the SCH sequence. That is, when a GCL sequence is generated, a GCL sequence that corresponds to the cell ID (=u) is generated, so that the receiving side is able to detect its cell by detecting the GCL sequence.

For example, according to non-Patent Document 1, a GCL sequence is mapped to an SCH (synchronization channel), as shown in FIG. 1A. Furthermore, the GCL sequence is mapped every other subcarrier in the frequency domain. When this signal is transformed into a time domain waveform through the IFFT, the SCH portion becomes a repetition of a certain waveform, as shown in FIG. 1B.

The synchronization timing is found using the differential correlation method utilizing the feature of this time domain waveform. The differential correlation method carries out the calculation for determining the correlation between the first half and the second half of a symbol, and therefore this correlation value increases when the same waveform is repeated. Therefore, timing can be synchronized by searching for the maximum value of the differential correlation result. FIG. 2 shows such a situation. As shown in FIG. 2A, since repetitive waveforms appear in the first half and the second half of the synchronization channel, a differential correlation value between the first waveform and the second waveform is obtained using a differential correlation circuit, as shown in FIG. 2B. As shown in FIG. 3, the peak of the differential correlation value then appears at the timing the synchronization channel is received, and the timing this peak appears can be regarded as the synchronization timing.

### Non-Patent Document 1: Motorola, “Cell Search and Initial Acquisition for EUTRA,” 3GPP TSG RAN WG1 Meeting #44 R1-060379

### Non-Patent Document 2: Ericsson, “E-UTRA Cell Search,” 3GPP TSG RAN WG1 Ad Hoc Meeting R1-060105

Non-Patent Document 3: ETRI, “Comparison of One-SCH and Two-SCH schemes for EUTRA Cell,” 3GPP TSG RAN WG1 Meeting #45 R1061117

### Non-Patent Document 4: NTT DoCoMo, et al., “BSCH Structure and Cell Search Method for E-UTRA Downlink,” 3GPP TSG RAN WG1 Meeting #45 R1-061186

### DISCLOSURE OF INVENTION

### Problems to be Solved by the Invention

However, since the GCL sequence varies depending on the GCL ID (i.e. cell ID), as also shown in equation 1, it is not always possible to find a differential correlation value that is suitable for use in synchronization timing detection. However, not much discussion has been done on this point heretofore.

It is an object of the present invention to provide a transmitting apparatus and a synchronization channel forming method capable of minimizing deterioration of the accuracy of synchronization timing detection on the receiving side even if the GCL sequence varies with the GCL ID.

### Means for Solving the Problem

The transmitting apparatus of the present invention adopts a configuration including: a GCL sequence generation section that generates a GCL sequence signal; a randomization section that randomizes the GCL sequence signal; and a subcarrier mapping section that maps the randomized GCL sequence signal to subcarriers in a frequency domain.

### ADVANTAGEOUS EFFECT OF THE INVENTION

The present invention randomizes the GCL sequence, and therefore the width of the peak of the differential correlation value of the GCL sequence signal narrows. As a result, the receiving side can detect accurate synchronization timing based on the GCL sequence signal. Therefore, even if the GCL sequence varies depending on the GCL ID, deterioration of the accuracy of synchronization timing detection on the receiving side can be minimized.

### BRIEF DESCRIPTION OF DRAWINGS

FIG. 1A shows the frame arrangement in a synchronization channel, and FIG. 1B shows a time domain waveform of the synchronization channel;

FIG. 2 illustrates the differential correlation value, FIG. 2A showing a time domain waveform of a synchronization channel, and FIG. 2B showing a schematic configuration of a differential correlation circuit;

FIG. 3 shows the relationship between the differential correlation value and synchronization timing;

FIG. 4 shows the relationship between GCL IDs and timing detection probability;

FIG. 5 shows the differential correlation power characteristics in the vicinity of peaks where the GCL ID is 1 and 32;

FIG. 6 shows the SCH power distribution characteristics in the time domain where the GCL ID is 1;

FIG. 7 shows the SCH power distribution characteristics in the time domain where the GCL ID is 32;

FIG. 8 shows the differential correlation power characteristics where the time domain SCH waveform is a pulse-repeating waveform, FIG. 8A showing an impulse-repeating waveform, FIG. 8B showing a schematic configuration of a differential correlation circuit, and FIG. 8C showing a differential correlation value;

FIG. 9 shows the differential correlation power characteristics when the time domain SCH waveform is a DC-repeating waveform, FIG. 9A showing a DC-repeating waveform, FIG. 9B showing a schematic configuration of a differential correlation circuit and FIG. 9C showing a differential correlation value;

FIG. 10 is a block diagram showing a configuration of the transmitting apparatus of Embodiment 1;

FIG. 11 shows the frame arrangement in a synchronization channel;

FIG. 12 is a block diagram showing a configuration of the receiving apparatus of Embodiment 1;

FIG. 13 is a block diagram showing another configuration example of the transmitting apparatus of Embodiment 1;

FIG. 14 is a block diagram showing another configuration example of the receiving apparatus of Embodiment 1;

FIG. 15 is a block diagram showing a configuration of the transmitting apparatus of Embodiment 2; and

FIG. 16 is a block diagram showing a configuration of the receiving apparatus of Embodiment 2.

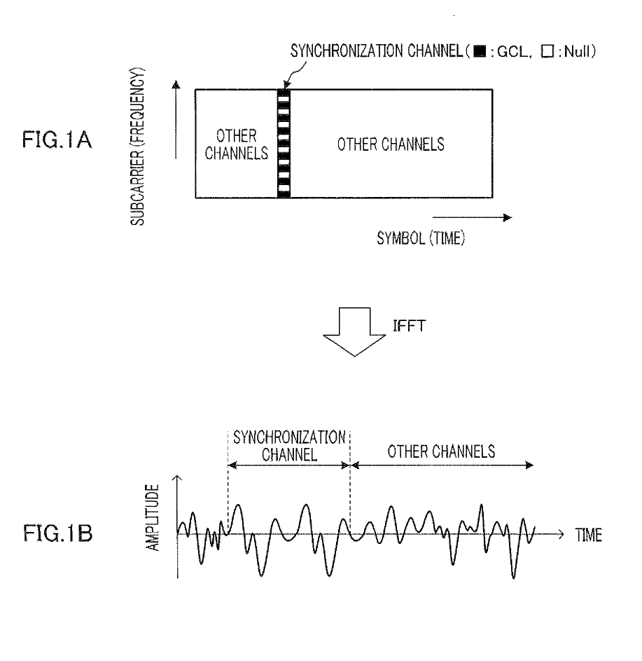

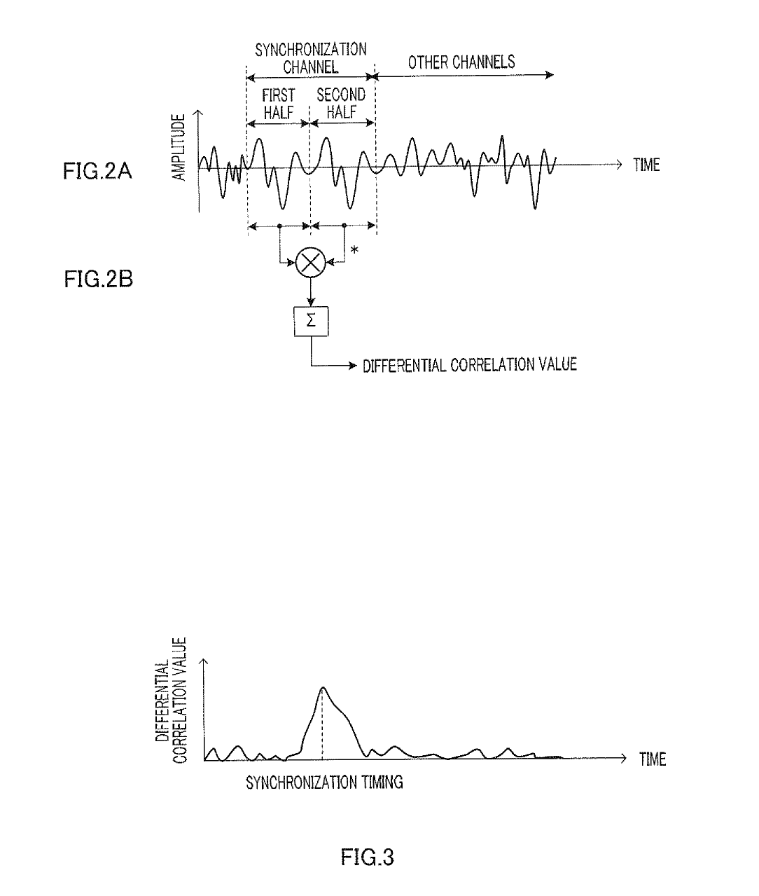

### BEST MODE FOR CARRYING OUT THE INVENTION

First, the process through which the present invention has been made will be explained.

Since a GCL sequence varies depending on the cell ID as shown in equation 1, when synchronization timing is detected by calculating the differential correlation value, timing detection performance may vary depending on the GCL sequence mapped to the SCH.

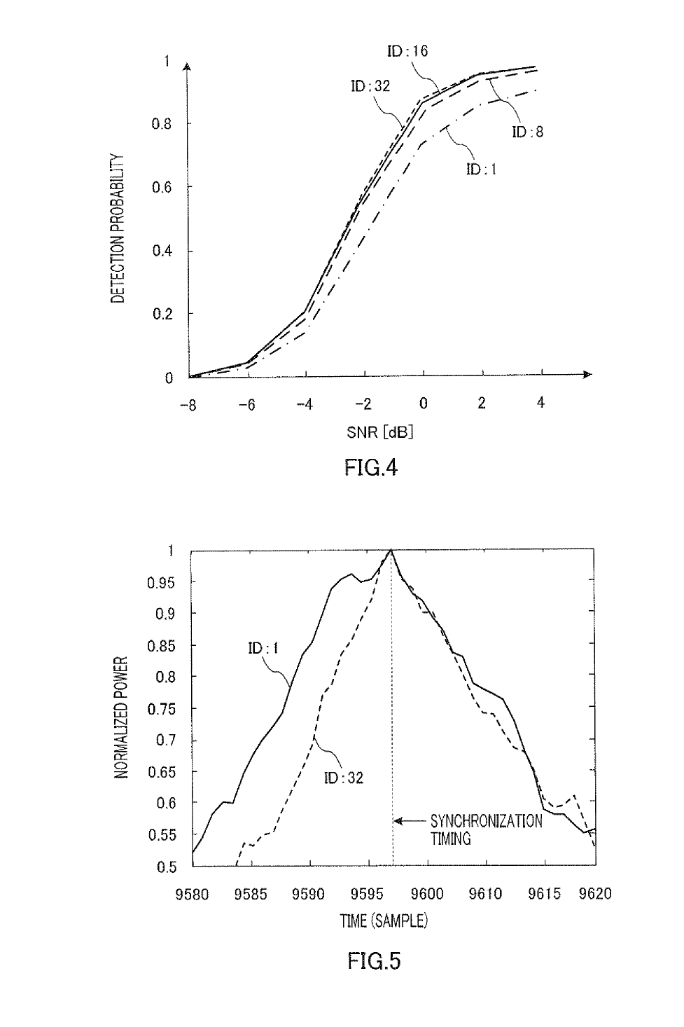

FIG. 4 shows the relationship between GCL IDs and timing detection probability. In FIG. 4, the horizontal axis is SNR and the vertical axis is detection probability. Furthermore, FIG. 4 shows the timing detection probability when the GCL ID is changed. This result shows that, the smaller the GCL ID, the lower the timing detection probability, and, especially when the GCL ID varies between 1 and 8, the detection probability also varies significantly.

Variations in the detection timing probability are produced because the width of the peak in the differential correlation characteristics increases when the GCL ID is small. FIG. 5 shows differential correlation power characteristics in the vicinity of peaks where the GCL ID is 1 and 32. In FIG. 5, the horizontal axis is time (sample) and the vertical axis is normalized power. This result shows that the smaller the GCL ID, the greater the spread of the peak width.

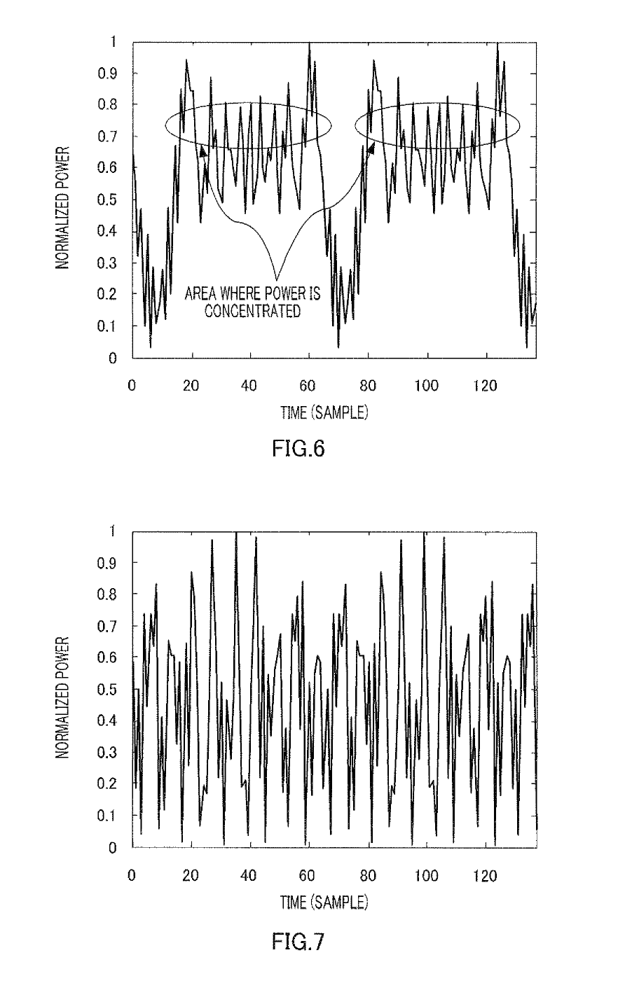

FIG. 6 shows the SCH power distribution characteristics in the time domain when the GCL ID is 1, and FIG. 7 shows the SCH power distribution characteristics in the time domain when the GCL ID is 32. In these figures, the horizontal axis is time and the vertical axis is normalized power. This result shows that when the GCL ID is small, areas where power is concentrated are created in the time domain (FIG. 6). This concentration of power causes the width of the peak in the differential correlation power characteristics to spread. Next, the reason will be explained.

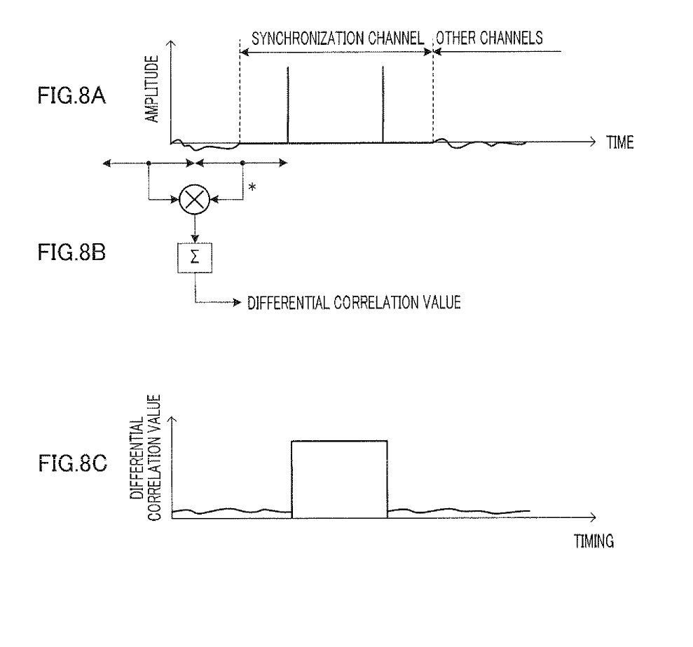

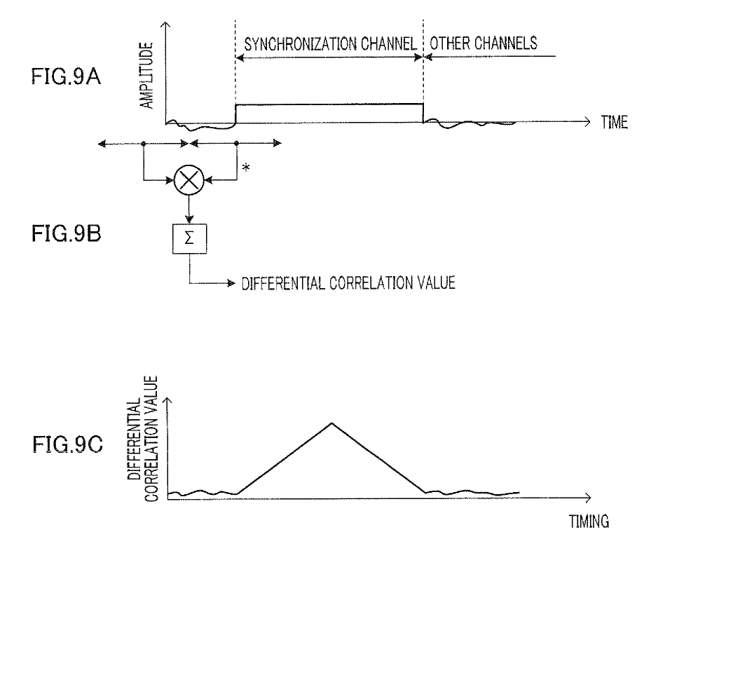

FIG. 8 and FIG. 9 show the SCH waveform and differential correlation power characteristics in the time domain. For ease of understanding, an impulse-repeating waveform (FIG. 8) and a DC-repeating waveform (FIG. 9) are taken as examples of the time domain SCH waveform. The impulse-repeating waveform can be considered as a case where the SCH power distribution is concentrated and the DC (Direct Current) repeating waveform is considered as a case where the SCH power distribution is spread out.

As shown in FIG. 8, when the SCH has an impulse-repeating waveform, the power of the impulse part becomes predominant over the rest, and therefore the differential correlation value remains at substantially the same level until the impulse part deviates from the correlation calculation range.

On the other hand, when the SCH has a DC-repeating waveform as shown in FIG. 9, the correlation increases as the area in which the SCH is included in the correlation calculation range increases, and therefore the timing at which the entire SCH is included in the correlation calculation range, that is, a desired position corresponds to the largest correlation.

Therefore, the width of the peak in the differential correlation power characteristics spreads out when the SCH power distribution is concentrated compared to the case where the SCH power distribution is spread out.

Based on the above considerations, the present inventors have found out that the GCL ID has the following features. That is, when the GCL ID of the GCL sequence mapped to the SCH is reduced (that is, when “u” in equation 1 is reduced), areas where power is concentrated are created in the SCH power distribution in the time domain. This causes the width of the peak in the differential correlation power characteristics to spread out, and as a result, the timing detection characteristics deteriorate.

The present inventors have arrived at the present invention by focusing upon such features of the GCL ID.

Hereinafter, embodiments of the present invention will be explained in detail with reference to the accompanying drawings.

### Embodiment 1

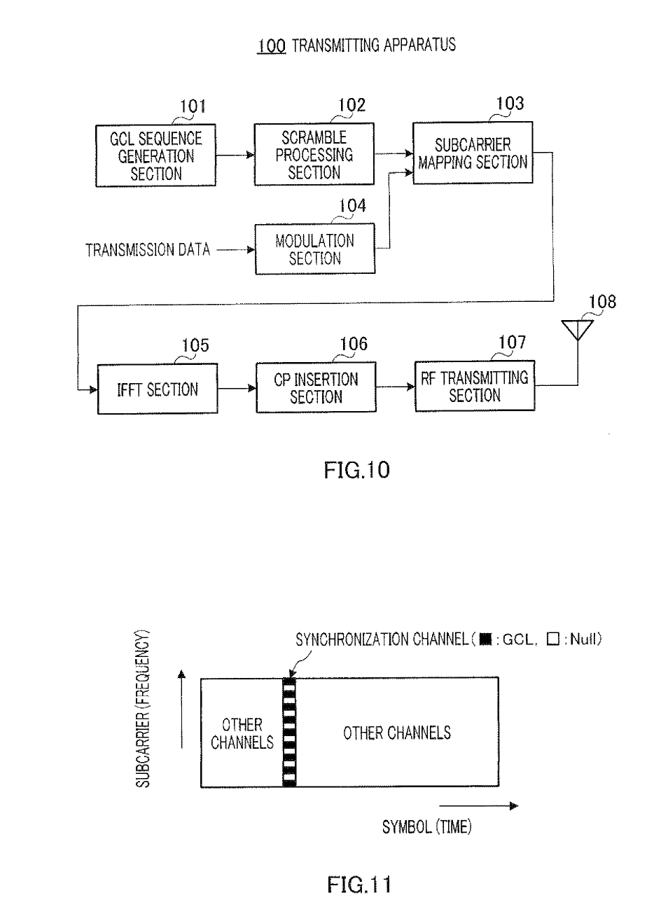

FIG. 10 shows a configuration of a transmitting apparatus according to Embodiment 1 of the present invention. Transmitting apparatus 100 is provided, for example, in a radio base station.

In transmitting apparatus 100, GCL sequence generation section 101 generates the GCL sequence to map to the SCH (synchronization channel). Actually, GCL sequence generation section 101 changes “u” in equation 1 according to the cell ID and thereby generates a GCL sequence that matches the cell ID. The generated GCL sequence is inputted to scramble processing section 102.

Scramble processing section 102 scrambles the GCL sequence by multiplying the generated GCL sequence by a scramble sequence. The scrambled GCL sequence is inputted to subcarrier mapping section 103.

In addition to the scrambled GCL sequence, transmission data modulated by modulation section 104 or the like is inputted to subcarrier mapping section 103. As shown in FIG. 11, subcarrier mapping section 103 maps the scrambled GCL sequence to subcarriers in the frequency domain of the SCH (synchronization channel). In addition, subcarrier mapping section 103 designates channels other than the SCH (“other channels” in the figure) as a data channel and a pilot channel, and maps data symbols and pilot symbols to these channels.

The mapped signal is subjected to an inverse Fourier transform in IFFT section 105, and, with a CP (cyclic prefix) inserted in CP insertion section 106, subjected to predetermined radio processing such as digital/analog conversion and up-conversion to a radio frequency band by RF transmitting section 107 and then transmitted from antenna 108 as a transmission signal.

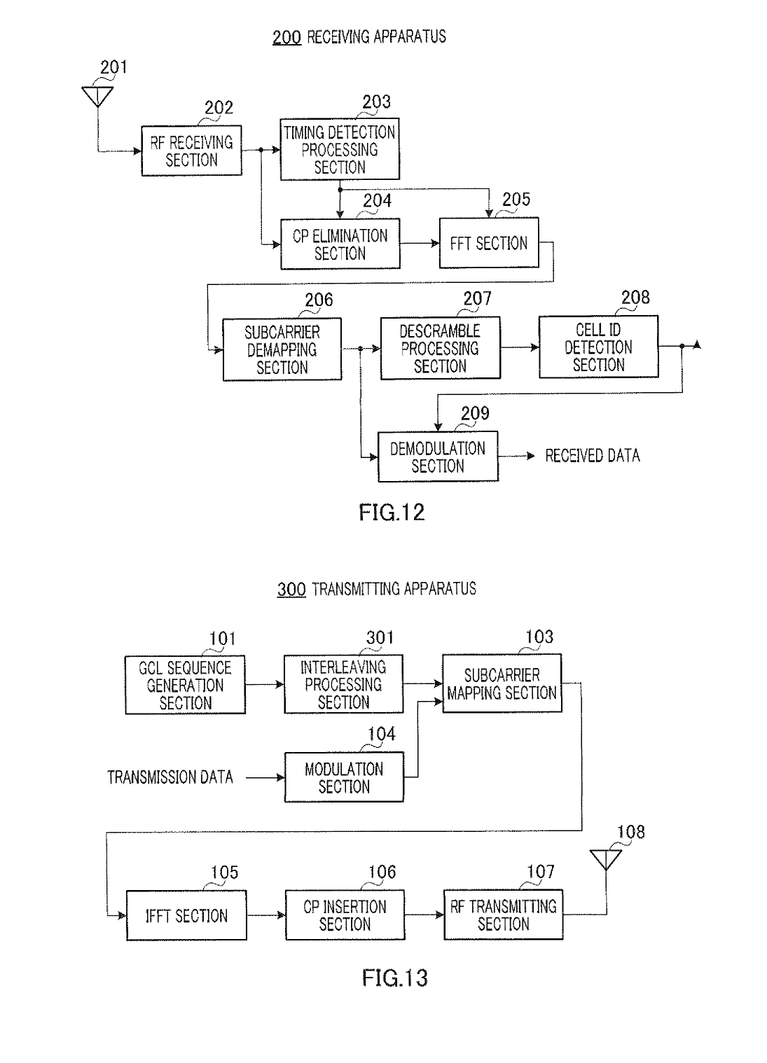

FIG. 12 shows a configuration of a receiving apparatus that receives and demodulates a transmission signal transmitted from transmitting apparatus 100. Receiving apparatus 200 is provided, for example, in a mobile station apparatus.

In receiving apparatus 200, RF receiving section 202 performs predetermined radio processing such as down-conversion to a baseband band and analog/digital conversion on the signal received from antenna 201 and sends the processed signal to timing detection processing section 203.

Timing detection processing section 203 obtains a differential correlation value of the GCL sequence mapped to the SCH (synchronization channel), detects the peak of the differential correlation value and thereby detects synchronization timing. Here, in the present embodiment, since transmitting apparatus 100 has scrambled the GCL sequence, the SCH power distribution is not concentrated and the width of the peak in the differential correlation value narrows. This allows timing detection processing section 203 to detect accurate synchronization timing. The synchronization timing detected by timing detection processing section 203 is sent to CP elimination section 204 and FFT section 205.

CP elimination section 204 eliminates a CP included in the received signal based on the detected synchronization timing. FFT section 205 performs a Fourier transform based on the detected synchronization timing. Subcarrier demapping section 206 extracts each channel.

Descramble processing section 207 performs descrambling by multiplying the synchronization channel extracted by subcarrier demapping section 206 by the complex conjugate of the scramble sequence. This causes the GCL sequence before scrambling to be reconstructed. The reconstructed GCL sequence is sent to cell ID detection section 208. Cell ID detection section 208 applies processing such as differential encoding to the GCL sequence, thereby detects a cell ID and sends the detected cell ID to demodulation section 209 or the like.

Demodulation section 209 demodulates the data channel extracted by subcarrier demapping section 206. In this case, demodulation section 209 carries out processing such as descrambling using a scramble code corresponding to the cell ID on the data channel. Although the configuration whereby transmission data is scrambled is not shown in FIG. 10 for simplicity of the drawing, data is normally multiplied by a scramble code corresponding to the cell ID.

As explained above, according to the present embodiment, scramble processing section 102 performs scramble processing on the GCL sequence, which causes the SCH power distribution on the receiving side to be spread out and the width of the peak of the differential correlation value to narrow. As a result, the receiving side can detect accurate synchronization timing. Therefore, even when the GCL sequence varies depending on the GCL ID, it is possible to realize transmitting apparatus 100 that is capable of reducing deterioration of the accuracy of synchronization timing detection on the receiving side.

A case has been described in the above embodiment where deterioration of the accuracy of synchronization timing detection on the receiving side is minimized by performing scramble processing on the GCL sequence, and in essence, effects similar to those in the above embodiment can be obtained by randomizing the GCL sequence.

FIG. 13 shows another preferred configuration example. Transmitting apparatus 300 in FIG. 13 in which parts corresponding to those in FIG. 10 are shown assigned the same reference numerals is provided with interleaving processing section 301 instead of scramble processing section 102 compared to transmitting apparatus 100 in FIG. 10. Interleaving processing section 301 interleaves the GCL sequence, that is, performs rearrangement according to a certain rule. This causes the SCH power distribution on the receiving side to be spread out and the width of the peak of the differential correlation value to narrow. As a result, the receiving side can detect accurate synchronization timing. Therefore, even when the GCL sequence varies depending on the GCL ID, it is possible to realize transmitting apparatus 300 capable of reducing deterioration of the accuracy of synchronization timing detection on the receiving side.

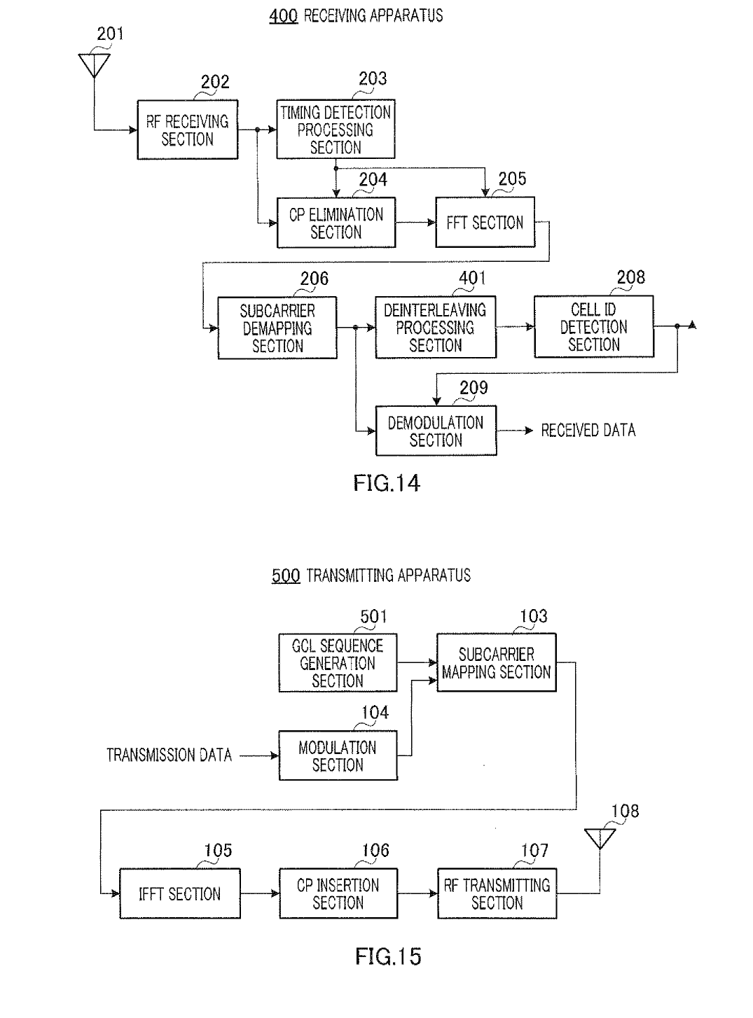

FIG. 14 in which parts corresponding to those in FIG. 12 are shown assigned the same reference numerals shows a configuration of a receiving apparatus that receives and demodulates a transmission signal transmitted from transmitting apparatus 300. Receiving apparatus 400 is provided with deinterleaving processing section 401 instead of descramble processing section 207 compared to receiving apparatus 200 in FIG. 12. Deinterleaving processing section 401 deinterleaves the synchronization channel extracted by subcarrier demapping section 206. In this way, the GCL sequence before interleaving is reconstructed.

### Embodiment 2

Above Embodiment 1 has presented a method for minimizing deterioration of the accuracy of synchronization timing detection on the receiving side by randomizing a GCL sequence. The present embodiment proposes prioritizing use of GCL sequences that narrow the width of the peak of the differential correlation value.

That is, it is understandable from the above considerations explained using FIG. 4 to FIG. 7 that as the GCL ID increases, the width of peak of the differential correlation value decreases and the accuracy of synchronization timing detection also increases, and therefore the present embodiment preferentially uses greater GCL IDs based on these considerations.

FIG. 15 in which parts corresponding to those in FIG. 10 are shown assigned the same reference numerals shows a configuration of the transmitting apparatus of the present embodiment. Transmitting apparatus 500 is different from transmitting apparatus 100 in FIG. 10 in the configuration of GCL sequence generation section 501 and has no scramble processing section 102. GCL sequence generation section 501 preferentially generates a GCL sequence having a greater GCL ID. Furthermore, based on the considerations in FIG. 4, for example, when the GCL ID is between 1 and 8 in particular, the probability of detecting synchronization timing decreases significantly, and therefore it is also effective to preferentially generate a GCL sequence without these GCL IDs.

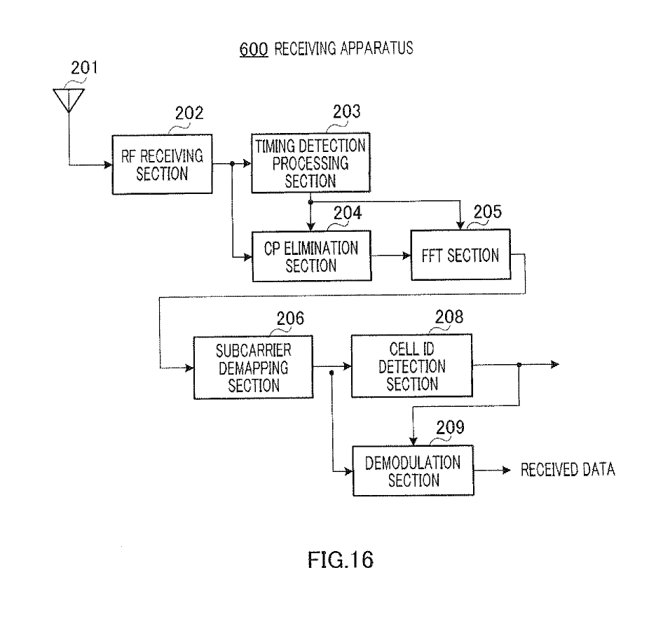

FIG. 16 in which parts corresponding to those in FIG. 12 are shown assigned the same reference numerals shows a configuration of a receiving apparatus that receives and demodulates a transmission signal transmitted from transmitting apparatus 500. Compared to receiving apparatus 200 in FIG. 12, receiving apparatus 600 has no descramble processing section 207.

The present embodiment preferentially uses GCL sequences having greater GCL IDs, and can thereby increase the probability that the receiving side is able to detect accurate synchronization timing.

A case has been explained in above Embodiments 1 and 2 where cell IDs is GCL IDs are associated with each other, but these IDs need not necessarily be associated with each other.

### INDUSTRIAL APPLICABILITY

The present invention is widely applicable to radio communication equipment that transmits a GCL sequence mapped to a synchronization channel of an OFDM signal.

1. A transmitting apparatus comprising:
a general chirp-like sequence generation section that generates a general chirp-like sequence signal;
a randomization section that randomizes the general chirp-like sequence signal; and
a subcarrier mapping section that maps the randomized general chirp-like sequence signal to subcarriers in a frequency domain.

2. The transmitting apparatus according to claim 1, wherein the randomization section comprises a scramble processing section that performs scramble processing on the general chirp-like sequence signal using a scramble is sequence signal.

3. The transmitting apparatus according to claim 1, wherein the randomization section comprises an interleaving processing section that performs interleaving processing on the general chirp-like sequence signal.

4. A synchronization channel forming method comprising:
a general chirp-like sequence generation step of generating a general chirp-like sequence signal;
a randomization step of randomizing the general chirp-like sequence signal; and
a subcarrier mapping step of mapping the randomized general chirp-like sequence signal to subcarriers in a frequency domain.
